(19) United States
(12) Patent Application Publication
(10) Pub. No.: US 2025/0006024 A1
(43) Pub. Date: Jan. 2, 2025

(54) Add On Devices and Methods

(71) Applicant: Hangzhou Timing Security Technologies Co., Ltd., Hangzhou PRC (CN)

(72) Inventors: Hexiao Wang, Hangzhou PRC (CN); Peter Morello, SR., Stuart, FL (US); Peter A. Morello, JR., Stuart, FL (US); Lin Wang, Hangzhou PRC (CN)

(73) Assignee: Hangzhou Timing Security Technologies Co., Ltd., Hangzhou PRC, ZJ (CN)

(21) Appl. No.: 18/733,776

(22) Filed: Jun. 4, 2024

Related U.S. Application Data
(60) Provisional application No. 63/471,235, filed on Jun. 5, 2023.

(51) Int. Cl. G08B 13/14

(52) U.S. Cl. CPC G08B 13/1463

(57) ABSTRACT

An add-on, process of using the add-on, process of making the add-on, and products produced thereby. An add-on, for example, for a sales rack can include a releasably securable sales rack holder and may include a surface or surfaces sized to fit a plurality of anti-theft devices.

### I. PRIORITY

The present patent application incorporates by reference as if fully stated herein and claims priority from U.S. Provisional Patent Application Ser. No. 63/471,235, filed Jun. 5, 2023.

### II. Summary

The disclosure below uses different prophetic embodiments to teach the broader principles with respect to articles of manufacture, apparatuses, processes for using the articles and apparatuses, processes for making the articles and apparatuses, and products produced by the process of making, along with necessary intermediates, directed to supporting antitheft devices.

This Summary is provided to introduce the idea herein that a selection of concepts is presented in a simplified form as further described below. This Summary is not intended to identify key features or essential features of subject matter, nor is this Summary intended to be used to limit the scope of claimed subject matter. Additional aspects, features, and/or advantages of examples will be indicated in part in the description which follows and, in part, will be apparent from the description, or may be learned by practice of the disclosure.

References cited herein are incorporated by reference as if fully stated herein. The following description and drawings are illustrative and are not to be construed as limiting. Numerous specific details are described to provide a thorough understanding of the disclosure. However, in certain instances, well-known or conventional details are not described to avoid obscuring the description. References to one or an embodiment in the present disclosure can be, but not necessarily are, references to the same embodiment; and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

Without intent to limit the scope of the disclosure, examples of apparatus, methods, and their related products, and accouterments of the foregoing, are illustrated according to the embodiments of the present disclosure. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

With the foregoing in mind, consider an apparatus, process of making, process of using, products, and products-by-process involving add on devices and methods related thereto.

### III. Figures

In the non-limiting examples of the present disclosure, please consider the following:

FIG. 1 is an illustration of an embodiment of an add-on for a sales rack, in combination with security devices and a rack member.

FIG. 2 is an illustration of an embodiment of an add-on for a sales rack, in combination with security devices.

FIG. 3 is an illustration of an embodiment of an add-on for a sales rack, in combination with security devices and a rack member.

FIG. 4 is an illustration of an embodiment of an add-on for a sales rack.

FIG. 5 is an illustration of an embodiment of an add-on for a sales rack.

FIG. 6 is an illustration of an embodiment of an add-on for a sales rack.

FIG. 7 is an illustration of an embodiment of an add-on for a sales rack.

FIG. 8 is an illustration of an embodiment of an add-on for a sales rack.

FIG. 9 is an illustration of an embodiment of an add-on for a sales rack.

FIG. 10 is an illustration of an embodiment of a click-in device.

FIG. 11 is an illustration of an embodiment of a click-in device.

FIG. 12 is an illustration of an embodiment of a click-in device.

### IV. Modes

Generally, an add-on can be added to an existing object or arrangement, such as a sales rack, to increase the capability of the object or arrangement, such as by adding consumer anti-theft security capability, e.g., consumer anti-theft capability. Such add-ons can be used on structures between fixtures and the antitheft devices. Fixtures can include store fixtures, such as at a point of sale, and store fixtures include: a sales racks (framework for holding or displaying products such as garments), shelving units (e.g., wall-mounted, freestanding, gondola, allow for product placement), end caps (located at the end of an aisle often to showcase featured or promotional items), pegboards and hooks (for hanging small items like tools, accessories, or packaged goods), dump bins (containers where products are “dumped” for easy browsing), mannequins and forms (often for displaying clothing, accessories, or jewelry to show how items look when worn), display tables (provide a flat surface for showcasing products, such as folded clothing, accessories, or small items), slatwalls (vertical panels with horizontal grooves where various accessories like hooks, shelves, and baskets that can be attached), spinner racks (rotating stands that display small items like costume jewelry and small packaged goods), shadow boxes (enclosed display cases with glass fronts, often used for highlighting premium or delicate items), feature walls (walls dedicated to specific product categories or themes, creating a focal point in the store), etc.

Security devices include consumer anti-theft devices, which include devices that are not alarmed, such as locks, disabling or destructive devices, and the like, and devices that are alarmed, such as Electronic Article Surveillance (EAS) Systems (security tags and sensors to trigger alarms when an item exits the store, or is moved in a store, without proper deactivation) and RFID Tags (security tags having specific resonance peaks monitored by RFID sensors to prevent theft).

A security device can be integrated into a fixture to produce a unified apparatus which includes one or more supports, or a security device can be connected to an object for protection and to a fixture, such as by screws and adhesives.

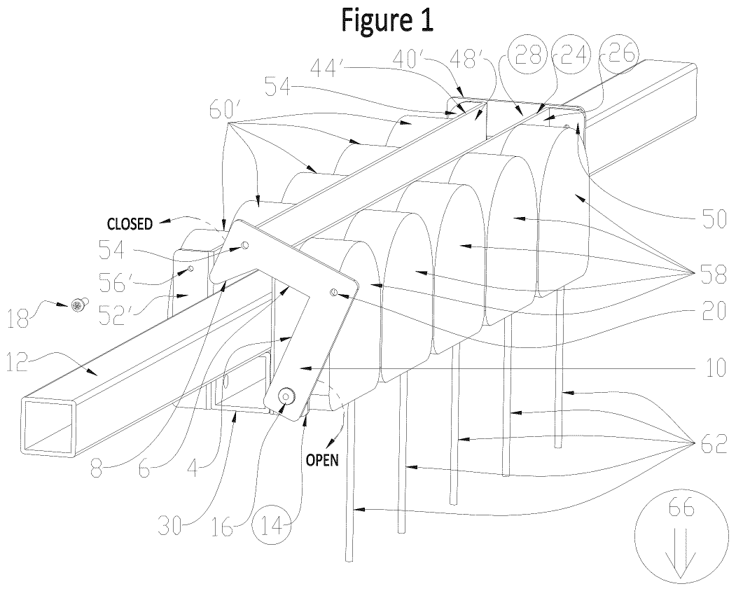

The add-on can, but need not always, be a holder. In the case of FIG. 1, there is a teaching illustratively for a sales rack (not shown) of a sales rack holder 2 comprised of a hook-like convergence. For example, there can be a first edge 4, a second edge 6, and a branch 8 which collectively describe a gap 9 or an interval to receive or accommodate some or all of sales rack member 12. First edge 4, a second edge 6, and branch 8 can be of arm 10 in an orientation substantially parallel to a length of a sales rack member 12, such as an arm of a sales rack. Arm 10 can, but need not always, be connected to lip 14.

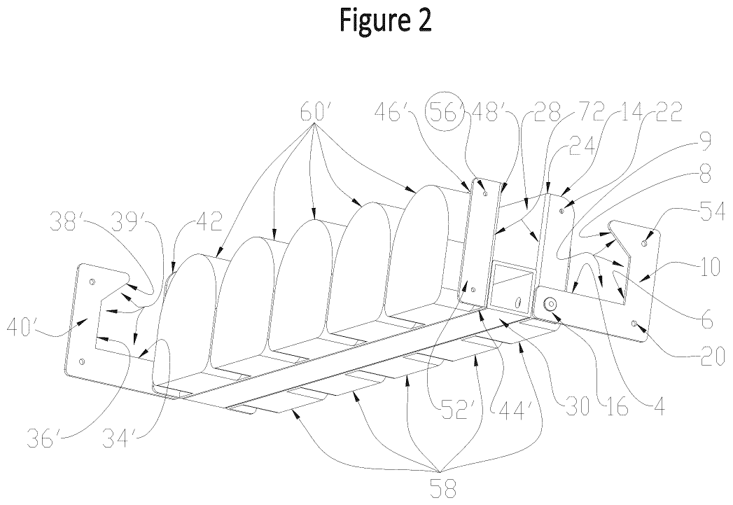

Rack holder 2 can, but need not always, be releasably securable to sales rack member 12. For example, in the embodiment in FIG. 1, arm 10 is rotatable about pivot 16 from an OPEN position, to receive sales rack member 12, and into a CLOSED position, to secure sales rack member 12, and if so desired, fixed in the CLOSED position by screw 18 inserted through a hole 20 and into a hole 22 (FIG. 2) of lip 14.

Lip 14 communicates with component 24 having an first surface 26 and an second surface 28 that can, but need not always, be in communication with a foot 30. Conceptually, second surface 28 and foot 30 extend at least some of gap 9 in a more 3-dimensional direction, more so when used in connection with sales rack holder 2′ discussed below.

FIGS. 1 and 2 show sales rack holder 2 in cooperation with a sales rack holder 32′ comprising another hook-like convergence, wherein arm 10 is shown in a more OPEN position, and foot 30 serves as a spacer between sales rack holder 2 and sales rack holder 32′.

For example, there can be a first edge 34′, a second edge 36′, and a branch 38′ which collectively describe a gap 39′ or an interval to receive sales rack member 12. First edge 34′, a second edge 36′, and branch 8′ can be of arm 40′ with gap 39′ in an orientation substantially parallel to a length of a sales rack member 12, such as an arm of a sales rack. Arm 40′ can, but need not always, be connected to lip 42′.

Lip 42′ communicates with component 44′ having a first surface 46′ and an second surface 48′ that can be in communication with a foot 30. Second surface 48′ and foot 10′ help with definition of a gap 39′ or interval, e.g., in a manner like gap 9. Arm 40′ can be similar in structure and operation to arm 10, e.g., pivot from an OPEN position in FIG. 2 to a CLOSED position in FIG. 1. In this configuration, sales rack holder 2 and sales rack holder 2′ are joined to collectively cooperate to be releasably securable.

In communication with component 24, there can be another lip 50, and in communication with component 44′, there can be another lip 52′. Another screw (not shown in FIG. 1) can be inserted through a screw hole 54 (FIG. 1) and into lip 52′ at hole 56′ to better define the gap or interval mentioned above.

First surface 26 can be sized to fit one or a plurality of anti-theft devices 58, and if used in conjunction with sales rack holder 2, sales rack holder 12′ can have first surface 46′ sized to fit one or a plurality of anti-theft devices 60′. For example, first surface 26 and first surface 46′ can (but need not always) accommodate identical anti-theft devices 58 and 60′, or mostly identical anti-theft devices 58 and 60′, with each of the anti-theft devices 58 and 60′ being in the range of 1 inch to 3 inches, such as inch or half-inch increments. Thus, first surface 26 and first surface 46′ could be in sized to accommodate increments, or at least increments, corresponding to the size of one of the anti-theft devices 58 and 60′. In one configuration, the anti-theft devices 58 and 60′ are evenly spaced apart, for example to accommodate similarly sized goods, such as coats or purses.

In the foregoing embodiments, the sales rack holder 2 is located intermediate the sales rack member 12 and the anti-theft devices 58, and if a sales rack holder 12′ is combined with the sales rack holder 2, the sales rack holder 12′ is intermediate the sales rack member 12 and anti-theft devices 60′.

Some or all of the anti-theft devices 58 and 60′ can have a tether and can, but need not always, have retractable tethers 24 and 64′. Once mounted to first surface 26, the anti-theft devices 58 collectively become a bank of anti-theft devices 58, and in a configuration of sales rack holder 2 and sales rack holder 12′, the anti-theft devices 58 and 60′ collectively become parallel banks of anti-theft devices 58 and 60′ that can, but need not always, be identical or mostly identical anti-theft devices 58 and 60′. Though not necessarily so, in this embodiment, anti-theft devices 58 and 60′ are organized to point the retractable tethers 62 and 64′ in orientation 66.

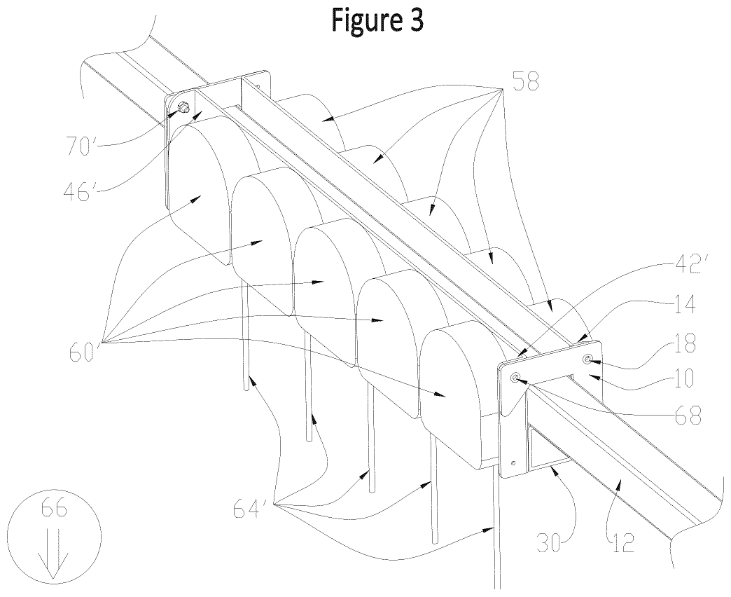

FIG. 3 shows the sales rack holder 2 and the sales rack holder 2′ with the arm 10 in the closed position and fixed by screw 18 to lip 14. FIG. 3 also illustrates that another screw 68, suggested above, can be used through screw hole 54 (FIG. 2) and into lip 42′. Each screw can be fixed in position by such as a nut 70′.

In FIGS. 1 and 2, sales rack member 12 is illustrated as having a rectilinear cross-sectional rack member area, which corresponds to a rectilinear interface for first edge 6 and second edge 8 of arm 10, illustrated in FIG. 2. A sales rack member 12 having a curvilinear cross-sectional area can be accommodated in sales rack holder 2 by such as an arm 10 or clamp with a curved surface or surfaces, e.g., in the manner of a pipe clamp.

While arm 10 with an interface for the first edge 6 and the second edge 8 that is rectilinear can be interchangeably or alternatively employed with an arm 10 for first edge 6 and second edge 8 of arm 10 that is curvilinear interface, e.g., and by a pivot 16 that allows the sales rack member 12 to be releasable, a curvilinear interface can also constrain a sales rack member 12 that is rectilinear. Where so desired, a shim (not illustrated) can also be removably inserted in corners of slot 72 (FIG. 2) to grip a sales rack member 12.

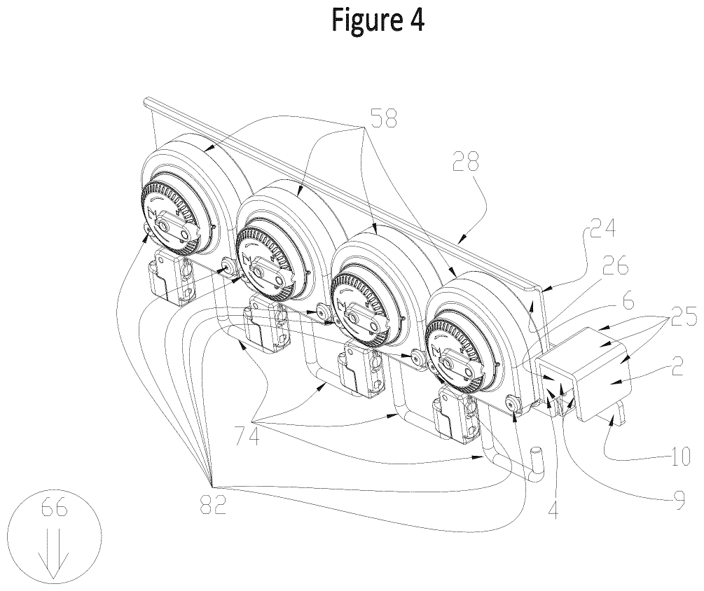

An alternative is to provide one or more covering, or one or more fitted partial covering of a cross-sectional rack member area of the sales rack member 4, such as a sleeve 25 (see, e.g., FIG. 4) or series of sleeves 25. In such an embodiment, some or all of sales rack member 12 is inserted into or accommodated in a sleeve-like form as sleeve 25. For example, the sleeve 25 can be a fitted covering or partial covering sized to accommodate some or all of the sales rack member 12.

Illustratively, the add-on for a sales rack can be used, for example to retrofit an unprotected rack (such as a clothing rack) into a rack that protects its goods. The add-on, such as is illustrated in FIGS. 1-3 can be attached to a sales rack member 12 of a sales rack (not shown but represented by sales rack member 12) by positioning the sales rack member 12 into slot 72 (or through a sleeve 25). Arm 10 is rotated from an OPEN position to a CLOSED position and secured with screw 18 (i.e., at least one screw), and where sales rack holder 2′ is employed, secured with screw 68. Thereafter, the retractable tethers 62 can be extended to ensnare a consumer good (not shown), e.g., thread each retractable tether 62 respectively through a coat arm, and connect to form a portion of the circuitry of one of the anti-theft devices 58, which is armed for consumer interaction. In this configuration, the coat can be removed from the sales rack and tried on by the consumer, due to the length of one of the tethers 62 extended by anti-theft device 58. After being tried on, the coat can be returned by the consumer to the sales rack; or if the consumer decides to purchase the coat, a salesperson can deactivate the corresponding device 58, allowing convenient removal of the coat. An attempted theft of the coat would trigger an alarm of the corresponding device 58. When the store prefers to remove the add-on, e.g., to use another embodiment of the add-on, arm 10 can be changed to an OPEN position, and the add-on can be removed from sales rack member 12.

Although an add-on for a sales rack, in combination with anti-theft devices 58 can be hingedly mounted to the sales rack member 12, e.g., to adjustably move from a parallel to a perpendicular orientation. FIG. 4 provides a teaching in which sales rack holder 2 is configured for use in an orientation substantially perpendicular to a length of a sales rack member 12, such as an arm of a sales rack. In FIG. 4, the hook-like convergence illustrated in FIGS. 1-3 is effectively made longer into a sleeve-like form, e.g., sleeve 25. In this embodiment, the add-on can include a sales rack holder 2 includes an elongated first edge 4, an elongated second edge 6, and an elongated branch 8. In this embodiment, second surface 28 and first surface 26 sized to fit one or a plurality of anti-theft devices 58.

Again, where the first surface 26 is sized to fit a plurality of anti-theft devices 58, first surface 26 can be sized to accommodate identical, or mostly identical, anti-theft devices 58, with each of the anti-theft devices 58 being, for example, in the range of 1 inch to 3 inches, such as inch or half-inch increments. Thus, first surface 26 can be in sized to accommodate these increments, or at least these increments, corresponding to the size of at least one of the anti-theft devices 58. Again, in one configuration, the anti-theft devices 58 are evenly spaced apart.

These anti-theft devices can, but need not always, be tether anti-theft devices 58 and similarly can have retractable tethers 24, such as is disclosed for example in U.S. Pat. Nos. 9,489,808 and 9,711,032 and WO 2019/209325, incorporated by reference as if fully stated herein. Once mounted to first surface 26, the anti-theft devices 58 collectively become a bank of anti-theft devices 58, and in a configuration of sales rack holder 2 and, in some cases, joined to sales rack holder 2′ (not shown in FIG. 4) of comparable structure and operation, such that the anti-theft devices 58 and 60′ collectively become parallel banks of anti-theft devices 58 and 60′ (not shown in FIG. 4) that can be identical or mostly identical anti-theft devices 58 and 60′ as in FIGS. 1-3. Though not necessarily so, in this embodiment, anti-theft devices 58 can be organized to point the retractable tethers 62 and 64′ (not shown in FIG. 4) in an orientation 66. Once mounted to first surface 26, the anti-theft devices 58 collectively become a bank or banks of anti-theft devices 58 disposed in the foregoing particular orientation 66. Unlike slot 72 in FIGS. 1-3, much or all the length of sales rack holder 2 has a perpendicular orientation to the length of sales rack member 12.

In FIG. 4 hooks 74 are provided. The books 72 can joined to sales rack holder 2, such as by welding. In another embodiment, such as hooks 72 could be joined to foot 30 in FIGS. 1-3, if so desired. Screws 82 can be inserted in peg-like structures 84 so as to secure anti-theft devices 58 to the first surface 26.

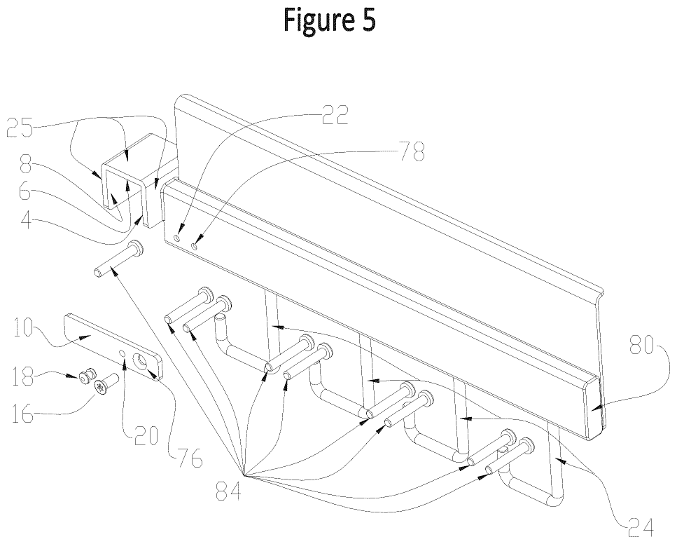

FIG. 5 is another illustration of an embodiment of an add-on for a sales rack, showing a side opposite a side where the anti-theft devices 58 are mounted in FIG. 4. Once mounted to first surface 26 in FIG. 4, the anti-theft devices 58 collectively become a bank of anti-theft devices 58 disposed in the substantially perpendicular orientation. The sleeve-like form of sleeve 25, comprised of first edge 4, second edge 6, and branch 8, which collectively extend in a third dimension to form a gap 9 for receiving some or all of sales rack member 12. Arm 10 is illustrated for assembly in a locked position, in this case, by means of screw 18 can be accommodated in hole 20 and then hole 22, and pivot 16 can be accommodated in hole 76 and then hole 78 in what is akin to an elongated lip 14 (in FIGS. 1-3) that is in the form of a housing 80 in FIG. 5.

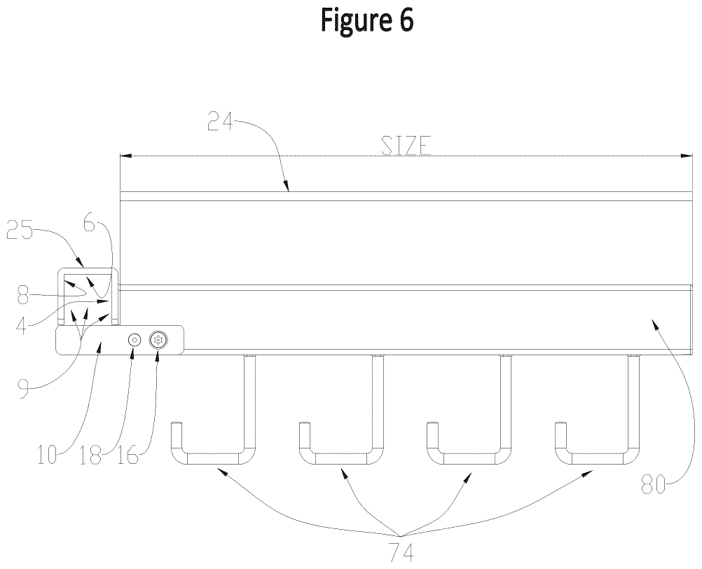

FIG. 6 illustrates a side opposite a side where the anti-theft devices 58 would be mounted by screws 82 so as, if so desired, to connect to housing 80 via peg-like structures 84. In another embodiment not shown in a figure, arm 10 can be secured to the housing 80 of sales rack holder 2 by such as by having screws, e.g., to connect with sleeve 25. Housing 80 can be joined to sales rack holder 2, e.g., by welding, and in an alternative, one of screw 18 and another screw can be used in place of a pivot 16.

The embodiments in FIGS. 4-6 can be joined in the manner of FIGS. 1-3 to form one bank of anti-theft security devices 58 parallel or substantially parallel to another bank of anti-theft security devices 60′.

Illustratively, the add-on illustrated in FIGS. 4-6 for a sales rack can be used, for example to retrofit on an unprotected, rack (such as a clothing rack) into a rack that protects its goods. This add-on embodiment can be attached to a sales rack member 4 of a sales rack (not shown) by positioning the sales rack member 4 into the sleeve 25, covering, or partial covering the sales rack member 12. Sales rack member 12 is secured, or rotated from an OPEN position to a closed position, with the screw 18 and pivot 16 securing the CLOSED position. Thereafter, the retractable tethers 62 (not shown in FIGS. 4-6) can be extended to protect or ensnare a consumer good, e.g., thread each retractable tether 62 through handles of, say, a purse, and connect to form a portion of the circuitry of one of the anti-theft devices 58, which is armed for consumer interaction.

In this configuration, say, a purse can be removed from the sales rack and inspected by the consumer, due to the length of one of the tethers 62 extended by a corresponding one of the security devices 58 in FIGS. 1 and 3. After being inspected, the purse can be returned by the consumer to the sales rack; or if the consumer decides to purchase the purse, a salesperson can deactivate one of the anti-theft devices 58, allowing convenient removal of the purse. An attempted theft of the purse would trigger an alarm of one of the anti-theft devices 58. When the store prefers to remove the add-on, e.g., to use another embodiment of the add-on, arm 10 can be changed to an OPEN position, and the add-on can be removed from sales rack member 12.

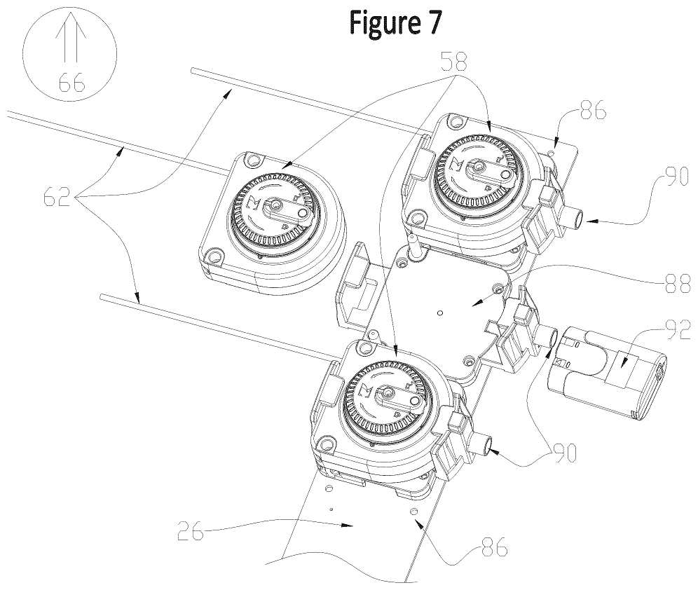

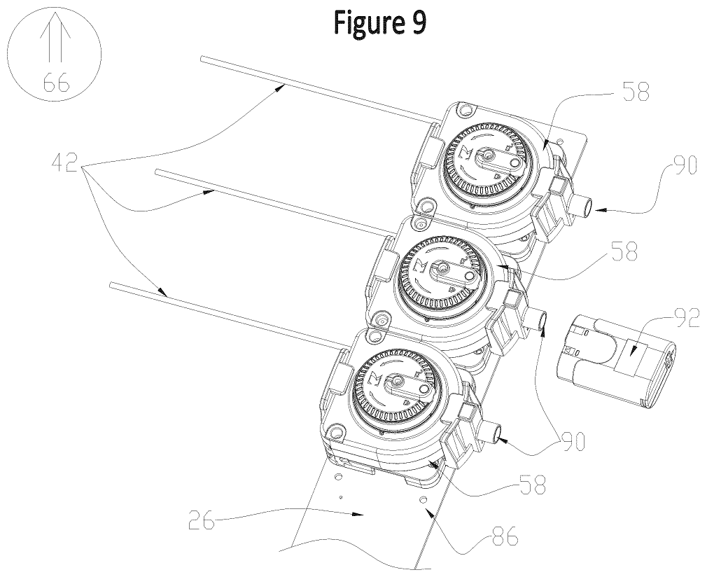

Turning now to FIGS. 7-9, there is a teaching of another embodiment in which a plurality of sales rack holders 2 are configured for orientation co-planar to a sales rack. In this embodiment, the add-on can include a sales rack holder 2, having the first surface 26 and the second surface 28 (not shown in FIGS. 7-9). A releasably securable sales rack holder 2 can include predrilled holes to accommodate one or more adjustable coupler arm locks (not shown) or the like. This mode of attachment can be particularly suitable for connecting the rack holder 2 to a crossmember or a grid wall or slatwall, and this embodiment—as are the others—is suitable for efficiently relocating secured goods from one location in a store to another without having to individually install security devices. The use of a standardized mounting for the anti-theft devices, such as a subsequently discussed click-in device 86 (which can be used in any of FIG. 19), can be used for interchanging anti-theft devices 58.

Yet again, the first surface 26 is sized to fit a plurality of anti-theft devices 58. For example, first surface 26 can be sized to accommodate identical anti-theft devices 58, or mostly identical anti-theft devices 58, with each of the anti-theft devices 58 being in the range of 1 inch to 3 inches, such as inch or half-inch increments. Thus, first surface 26 would be in sized to accommodate increments, or at least increments, corresponding to the size of one of the anti-theft devices 58. Yet again, in one configuration, the anti-theft devices 58 are evenly spaced apart.

Once mounted to first surface 26, the anti-theft devices 58 collectively become a bank of anti-theft devices 58, and in a configuration of sales rack holder 2, and if so desired sales rack holder 2′, with the anti-theft devices 60′ collectively being parallel banks of anti-theft devices 60′ that can be identical anti-theft devices 60′ or mostly identical anti-theft devices 60′. Though not necessarily so, in this embodiment, anti-theft devices 58 and 60′ are organized to point the retractable tethers 62 and 64′ in orientation 66.

Illustratively, the add-on illustrated in FIGS. 7-9 can be used, for example to retrofit on a sales rack, i.e., unprotected, rack (such as a tool rack) into a rack that protects its goods. This add-on embodiment can be attached to a sales rack member 4 (not shown in FIG. 7) of a sales rack (not shown) by positioning the sales rack holder 2 adjacent to the sales rack and removably securing the sales rack holder 2 to the sales rack. This can be accomplished, for example, by feeding through the predrilled holes an adjustable coupler latch lock (not shown), for example, by securing the adjustable coupler latch lock to entrap sales rack member 4. Thereafter, the retractable tethers 62 can be extended to ensnare a consumer good, e.g., a hand tool, small appliance, etc. and connect to form a portion of the circuitry of anti-theft device 58, which is armed for consumer interaction. In this configuration, a good can be removed from the rack and inspected by the consumer, due to the length of the tethers 60 extended by the anti-theft devices 58. After being inspected, the good can be returned by the consumer to the rack; or if the consumer decides to purchase the good, a salesperson can deactivate anti-theft device 58, allowing convenient removal of the good. An attempted theft of the good would trigger an alarm of anti-theft device 58. When the store prefers to remove the add-on, e.g., to use another embodiment of the add-on, the adjustable coupler latch lock can be unlocked, and the add-on can be removed from sales rack member 4.

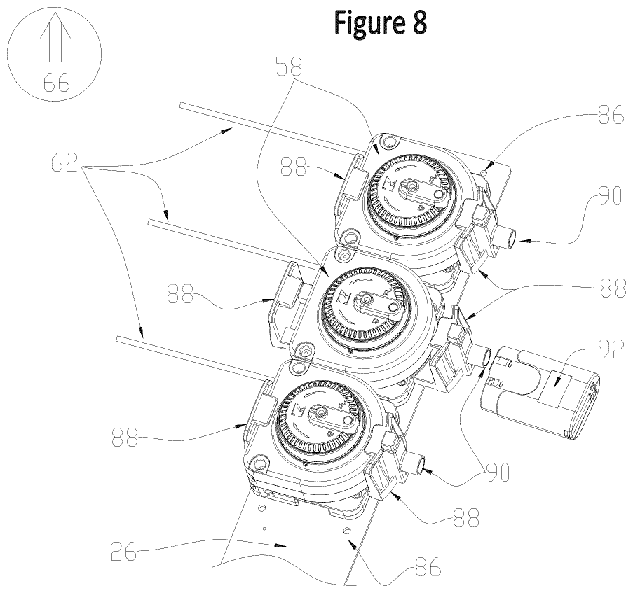

One manner of accommodating the above-mentioned sizing for the anti-theft devices 58 is to align them in contact with each other, as is illustrated in FIGS. 1-4 and 7-9. Alternatively, the above-mentioned sizing for the anti-theft devices 58 can be conveniently carried out by a click-in device 88 or other preconfigured receptacle for one or more anti-theft devices 58 that are adjacent or evenly spaced apart. A click-in device 88 or such a receptacle can be attached to a first surface 26, e.g., in advance of receiving a click-in device 42 so as to readily permit attachment and detachment of the respective anti-theft device 58, such as by a lock 90 that can be unlocked by a magnetic or other unlocking device 92, such as a magnet or broadcast unlocking device. Compare FIG. 7, which has one of the anti-theft devices 58 separated from an empty click-in device 88, while other anti-theft devices 58 are secured in respective click-in devices 88, with FIG. 8, which has the previously separated one of the anti-theft devices 58 now located in the click-in device 88.

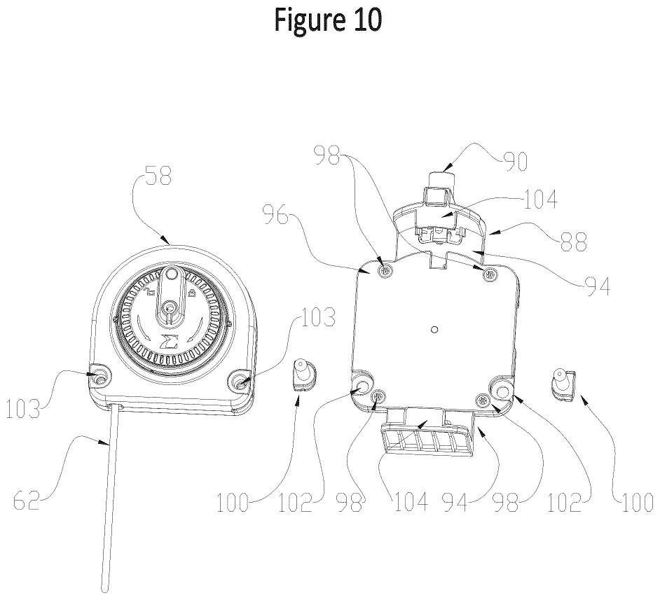

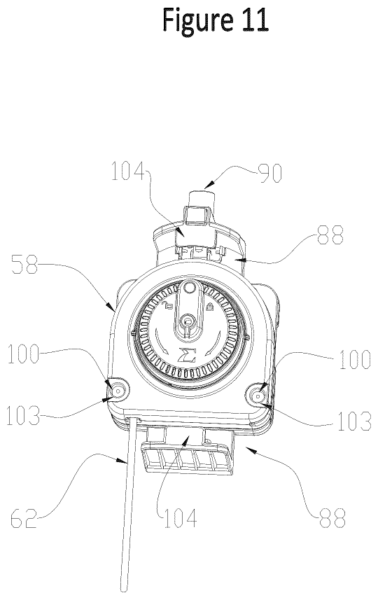

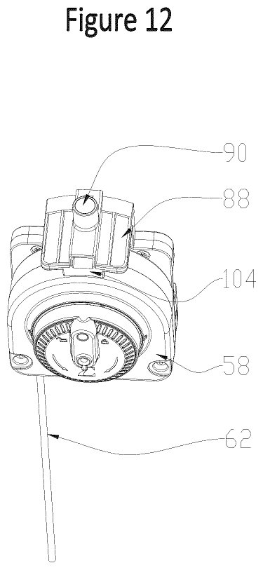

FIGS. 10-11 show a click-in device 88, a lock 90 for anti-theft device 58, and one of the tethers 62, with the click-in device 88 disconnected from the anti-theft device 58. The click-in device 88 can have a magnetic (or other type of) locking bracket 94 slidably mounted to a palette 96. Screws (not shown) can be inserted in screw holes 98 to mount the click-in device 88 to a surface 6. The click-in device 88 can have one or more pins 100 extending through holes 102 to mate with at least one of the holes 103 in the anti-theft device 58, thereby aligning the anti-theft device 58. Compare FIG. 10 with FIG. 11 to see the combining of the click-in device 88 and the anti-theft device 58. The magnetic locking bracket 88 contacts around the anti-theft device 58 as lips 104 secure the anti-theft device 58 into magnetic locking bracket 94, of the click-in device 88, which clicks shut and is secured by lock 90, entrapping the anti-theft device 58. See FIG. 12. If so desired, anti-theft device 58 can be further secured to palette 96 by an adhesive, etc.

In an alternative implementation, the click-in device 88 can be used without the surface 6 or 6′, such as by using 3M adhesive or screws to mount the click-in device 88 into a table or fixture. In any case, plastic supports can be snapped on to cover the holes 103.

When used on a surface 6 or 6′, the click-in devices 88 can provide the above-mentioned incremental spacing, such as in a side-by-side configuration, or be aligned in a daisy chain configuration, such as by hooks (not shown) connecting the click-in devices 88.

Note that referencing the types of sales rack holder orientations is somewhat arbitrary, for example, a device of the sort shown in FIG. 1-3 or 4-6 can be mounted to a planar surface, and a device of the sort shown in FIGS. 7-9 can be mounted to a sales rack member 12 in parallel or perpendicular orientation to sales rack member 12, e.g., any of the holders can be suspended from a portion of a sales rack or other fixture, etc. FIGS. 1-11 illustrate various embodiments in which a sales rack holder 2 is in structural communication with one or more anti-theft devices 58, and similarly for sales rack holder 12′.

In sum, it is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. Variation from amounts specified in this teaching can be “about” or “substantially,” so as to accommodate tolerance for such as acceptable manufacturing tolerances.

The foregoing description of illustrated embodiments, including what is described in the Abstract and the Modes, and all disclosure and the implicated industrial applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

1. An add-on for a sales rack, the add-on including:
a releasably securable sales rack holder in structural communication with one or more anti-theft tether devices.

2. The add-on of claim 1, wherein the one or more anti-theft tether devices comprises one or more anti-theft retractable tether devices.

3. The add-on of claim 1, wherein:
the one or more anti-theft tether devices comprises a plurality of anti-theft retractable tether devices;
the releasably securable sales rack holder comprises a surface; and
at least some of the plurality of anti-theft tether anti-theft devices are each mounted to the surface by a click-in device.

4. The add-on of claim 3, wherein the sales rack holder is a clothing sales rack holder.

5. The add-on of claim 1, wherein:
the one or more anti-theft tether devices comprises a plurality of anti-theft retractable tether devices;
the releasably securable sales rack holder comprises a surface sized to fit the plurality of the anti-theft tether devices in a side-by-side and planar orientation; and
the surface is located for parallel or substantially parallel orientation when the releasably securable sales rack holder is secured to a sales rack member.

6. The add-on of claim 5, wherein the sales rack holder is a clothing sales rack holder.

7. The add-on of claim 5, wherein the surface is sized to increments in a range of 1 inch to 3 inches, or increments of at least 1 inch to 3 inches, to accommodate corresponding ones of the anti-theft retractable tether devices.

8. The add-on of claim 5, wherein:
the plurality of anti-theft retractable tether devices forms a bank of anti-theft retractable tether devices with tethers having an orientation that substantially defines a first plane; and
the releasably securable sales rack holder is joined to another releasably securable sales rack holder in structural communication with a plurality of retractable anti-theft tether devices that form a second bank of retractable anti-theft tether devices with tethers having an orientation that substantially defines a second plane that is substantially parallel to the second plane.

9. The add-on of claim 1, wherein:
the one or more anti-theft tether devices comprises a plurality of anti-theft retractable tether devices;
the releasably securable sales rack holder comprises a surface sized to fit the plurality of the anti-theft tether devices in a side-by-side and planar orientation; and
the surface is located for perpendicular or substantially perpendicular orientation when the releasably securable sales rack holder is secured to a sales rack member.

10. The add-on of claim 9, wherein the surface is sized to increments in a range of 1 inch to 3 inches, or increments of at least 1 inch to 3 inches, to accommodate corresponding ones of the anti-theft retractable tether devices.

11. The add-on of claim 9, wherein:
the plurality of anti-theft retractable tether devices forms a bank of anti-theft retractable tether devices with tethers having an orientation that substantially defines a first plane; and
the releasably securable sales rack holder is joined to another releasably securable sales rack holder in structural communication with a plurality of retractable anti-theft tether devices that form a second bank of retractable anti-theft tether devices with tethers having an orientation that substantially defines a second plane that is substantially parallel to the second plane.

12. The add-on of claim 9, wherein the sales rack holder is a clothing sales rack holder.

13. The add-on of claim 9, wherein the releasably securable sales rack holder comprises a covering or a partial covering of a cross-sectional rack member area.

14. The add-on of claim 9, wherein at least some of the plurality of anti-theft tether anti-theft devices are each mounted to the surface by a click-in device.

15. A method of using an add-on for a sales rack, the method including:
Installing, on a clothing rack, a releasably securable sales rack holder in structural communication with one or more anti-theft tether devices.

16. A method of making an add-on for a sales rack, the method including:
connecting a releasably securable sales rack holder into structural communication with one or more anti-theft tether devices.

17. An apparatus comprising:
a click-in device having a lock and lips to releasably secure an anti-theft device to a surface.
